(19) United States
(12) Patent Application Publication
(10) Pub. No.: US 2009/0122460 A1
(43) Pub. Date: May 14, 2009

(54) Semiconductor Device and Method for Producing the Same

(76) Inventors: Alexander Gschwandtner, Munich (DE); Stefan Pompl, Landshut (DE); Wolfgang Lehnert, Lintach (DE); Raimund Foerg, Straubing (DE)

Correspondence Address: SLATER & MATSIL LLP, 17950 PRESTON ROAD, SUITE 1000, DALLAS, TX, 75252, US

(21) Appl. No.: 11/938,436

(22) Filed: Nov. 12, 2007

(51) Int. Cl. H01G 4/008; H01G 9/042

(52) U.S. Cl. 361/305; 361/524; 438/393; 257/E21.021

(57) ABSTRACT

A semiconductor device includes a semiconductor layer with a first electrode formed by a sintered, conductive, porous granulate and formed in or on the semiconductor layer or in or on at least one insulating layer arranged on the semiconductor layer; furthermore dielectric material covering the surface of the sintered, conductive, porous granulate, and a second electrode at least partially covering the dielectric material, wherein the dielectric material electrically insulates the second electrode from the first electrode.

### BACKGROUND

Embodiments of the present invention relate to a semiconductor device with an integrated capacitor and a method for producing the same.

### BRIEF DESCRIPTION OF THE DRAWINGS

With reference to the following description of the embodiments of the present invention, it is to be noted that, for simplification reasons, the same reference numerals will be used in the different figures for functionally identical or similarly acting or functionally equal, equivalent elements or steps throughout the description.

FIG. 1 shows a schematic cross-sectional view of a semiconductor device according to an embodiment of the invention;

FIG. 2 shows a magnification of portion A of FIG. 1;

FIG. 3a shows a cross-sectional view of a semiconductor device according to an embodiment of the present invention;

FIG. 3b shows another cross-sectional view of a semiconductor device according to another embodiment of the invention;

FIG. 4 shows a flowchart of an embodiment of a method of producing a semiconductor device;

FIG. 5a schematically shows a semiconductor layer after forming a depression in the semiconductor layer;

FIG. 5b shows the schematic cross-section of the semiconductor device after forming two barrier layers;

FIG. 5c shows the schematic cross-sectional image of the semiconductor device after forming an electrode layer;

FIG. 5d shows the schematic cross-section of the semiconductor device after introducing a sinterable, conductive granulate into the depression of the semiconductor layer, according to an embodiment of the present invention;

FIG. 5e shows the schematic cross-section of the semiconductor device after sintering, so that the first electrode is formed of the sintered, conductive, porous granulate, according to an embodiment of the invention;

FIG. 5f shows the schematic cross-section of the semiconductor device after covering the surface of the sintered, conductive, porous granulate by a dielectric material;

FIG. 5g shows a schematic cross-section of the semiconductor device after applying a second electrode, which at least partially covers the dielectric material, according to an embodiment of the present invention;

FIG. 6a shows the schematic cross-section of a semiconductor device after introducing a pre-sintered, conductive, porous granulate into the depression of a semiconductor layer, according to another embodiment of the method of producing a semiconductor device;

FIG. 6b shows the schematic cross-section of the semiconductor device after sintering the pre-sintered, conductive, porous granulate so that the first electrode is formed of the sintered, conductive, porous granulate; and

FIG. 6c shows a schematic cross-section of a semiconductor device after applying a second electrode, which at least partially covers the dielectric material, according to the embodiment of FIGS. 6a, 6b.

### DETAILED DESCRIPTION OF ILLUSTRATIVE EMBODIMENTS

Embodiments of the invention provide a semiconductor device with a semiconductor layer, a first electrode, which is formed by a sintered, conductive, porous granulate, and which is formed in or on the semiconductor layer or in or on at least one insulating layer arranged on the semiconductor layer. Moreover, the semiconductor device comprises a dielectric material, which covers the surface of the sintered, conductive, porous granulate, and a second electrode, which at least partially covers the dielectric material, wherein the dielectric material electrically insulates the second electrode from the first electrode.

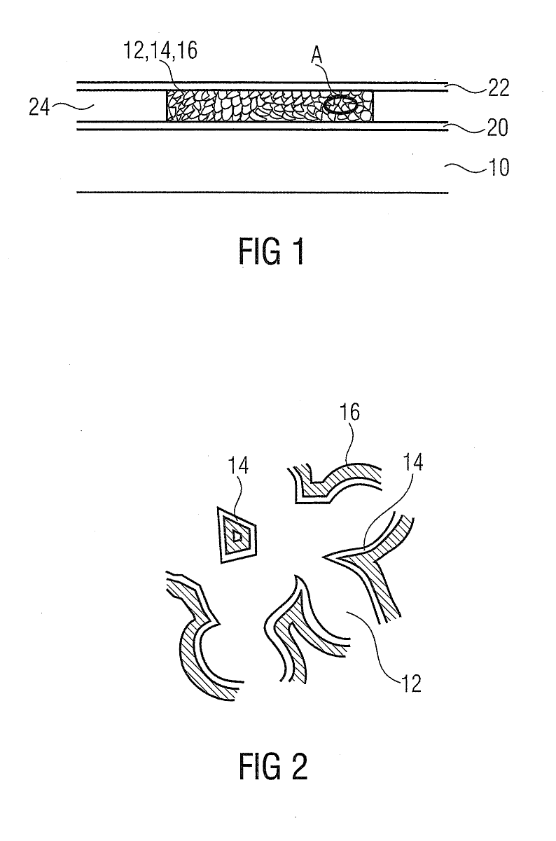

With reference to FIGS. 1-6c, embodiments relating to the semiconductor device and the method for producing the same will be explained in detail.

FIG. 1 shows a cross-sectional view of an embodiment of the invention, and FIG. 2 shows a magnification of section A in FIG. 1. According to FIGS. 1 and 2, the semiconductor device comprises a semiconductor layer 10, a first electrode 12, a dielectric material covering the surface of the first electrode 12 and a second electrode 16. The dielectric material 14 is arranged between the first electrode 12 and the second electrode 16 and insulates them from each other such that a capacitor is formed. The first electrode is formed by a sintered, conductive porous granulate and may be electrically connected to a first electrode layer 20. The second electrode may be connected to a second electrode layer 22. The first electrode 12, the dielectric material 14 and the second electrode 16 may be formed in a recess of an insulating layer formed on the semiconductor layer 10.

In an embodiment, the first electrode is formed in a recess or depression in the semiconductor layer or in a recess or depression in at least one insulating layer arranged on the semiconductor layer.

In an embodiment, the first electrode is separated from the semiconductor layer by at least one barrier layer. In an embodiment, the first electrode may be connected to an electrode layer in an electrically conductive manner.

In a further embodiment of the present invention, the sintered, conductive, porous granulate is formed by grains of a grain size of about 10 nm to about 1 μm. These grains may be grown together by the sintering into a porous conglomerate or a nanogranulate matrix connected in an electrically conductive manner. This conglomerate may be in electrically conductive connection to an electrode layer.

The sintered, conductive, porous granulate, or the sinter body, may, for example, comprise niobium, tantalum, or aluminum.

In another embodiment, the dielectric material, which electrically insulates the first and second electrodes from each other, may comprise a first dielectric layer or a first dielectric material, which lines the sintered, conductive, porous granulate, and a second dielectric material, which covers the first dielectric material.

In a further embodiment, the dielectric material or the first dielectric material comprises niobium pentoxide, tantalum pentoxide, or aluminum oxide. In another embodiment, a second dielectric material, which covers the first dielectric material, comprises aluminum oxide.

In a further embodiment of the present invention, the second electrode is a metal electrode, a metal nitride electrode, e.g., titanium nitride (TiN), tantalum nitride (TaN) or an electrolyte electrode. The electrolyte electrode may, for example, be manganese dioxide or also another solid electrolyte. The semiconductor device with integrated capacitor may, for example, be a polar capacitor, in which the anode, which is the positive pole, is formed by the sinter body, and the cathode, which is the negative pole, by the second electrode. That is, a polar capacitor should only be operated in the polarization direction indicated, since otherwise destruction of the capacitor may occur.

In another embodiment of the present invention, it has been shown that the semiconductor device may also comprise a non-polar or bipolar integrated capacitor. In this embodiment, the second electrode may be constructed of a metal, and the dielectric of the capacitor may comprise a first dielectric material, which covers the sintered, conductive, porous granulate, and a second dielectric material, which covers the first dielectric material.

In another embodiment, an integrated electric circuit may be a semiconductor device with a semiconductor layer, a first electrode, which is formed by a sintered, conductive, porous granulate, and which is formed in or on the semiconductor layer or in or on at least one insulating layer arranged on the semiconductor layer. Moreover, the semiconductor device may comprise a dielectric material, which covers the surface of the sintered, conductive, porous granulate, and a second electrode, which at least partially covers the dielectric material, wherein the dielectric material electrically insulates the second electrode from the first electrode. The integrated electric circuit may comprise, apart from the semiconductor device, further semiconductor devices, such as field effect transistors, diodes or bipolar transistors.

It is to be outlined that the term “formed on” is not used in the sense “formed directly on” herein. Rather, it is intended that this term also encompasses cases in which a first item is formed on a second item with one or more third items arranged there between.

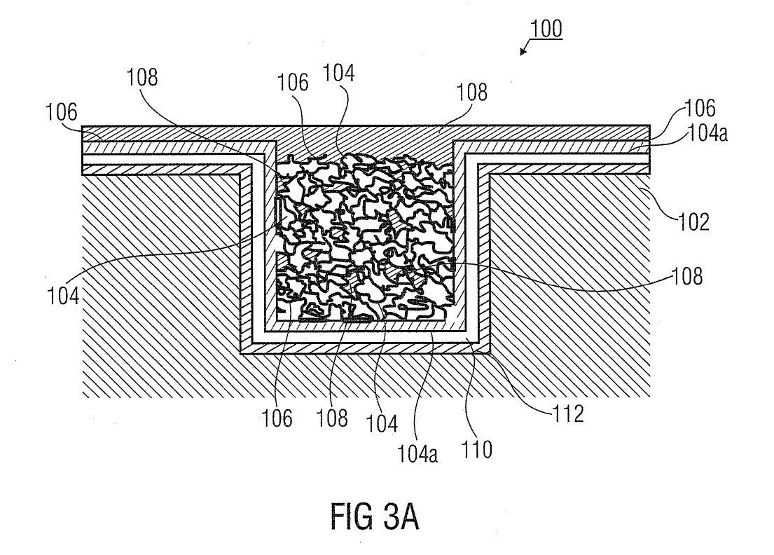

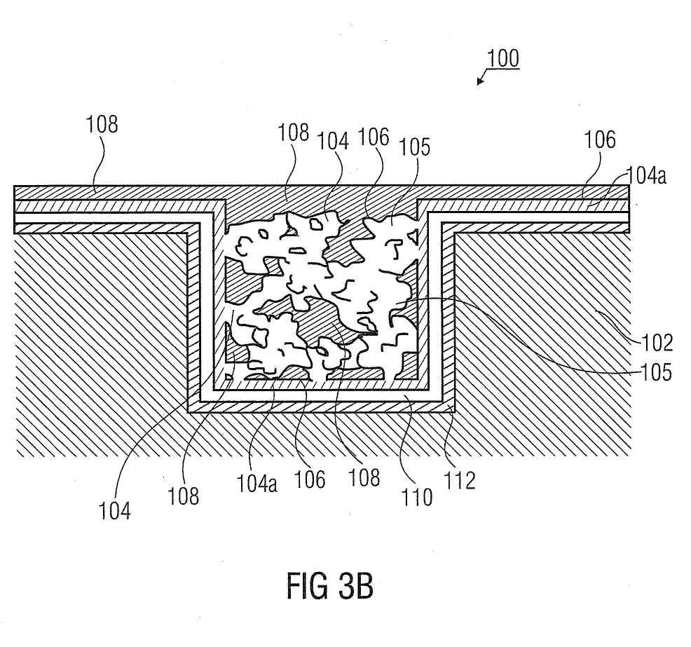

In FIG. 3a, another embodiment of a semiconductor device according to an embodiment of the invention is schematically shown in a cross-sectional view. The semiconductor device 100 comprises a semiconductor layer 102 with a first electrode 104, which is formed by a sintered, conductive, porous granulate. A dielectric material 106 covers the surface of the sintered, conductive, porous granulate 104. Moreover, the semiconductor device 100 comprises a second electrode 108 at least partially covering the dielectric material 106, wherein the dielectric material 106 electrically insulates the second electrode 108 from the first electrode 104.

As shown in FIG. 3a, the semiconductor device may comprise one or more barrier layers 110, 112 and an electrode layer 104a. The first electrode 104 and/or the electrode layer 104a may be separated from the semiconductor layer 102 by at least one of the barrier layers 110 and 112. Thus, a capacitance is formed by the first electrode 104, which is formed by the sintered, conductive, porous granulate, and by the second electrode, which is insulated from the first electrode by the insulation layer 106. In this embodiment, the semiconductor device is a capacitor formed by the first electrode 104, the second electrode 108 and a dielectric 106 separating and electrically insulating the first and the second electrode and being integrated into a semiconductor layer.

FIG. 3b depicts another embodiment of the invention. In this embodiment the semiconductor device 100 comprises the same configuration as described in context to FIG. 3a except the conformation of the sintered, conductive, porous granulate. As it is depicted in FIG. 3b the first electrode 104 formed by the sintered, conductive porous granulate comprises a granulate or sinter body, wherein the granulate or grain size of the sinter body is larger than the sintered, conductive, porous granulate depicted in FIG. 3a. The grains 105 of the sintered body, forming the first electrode may comprise a size approximately between about 1 μm and about 10 μm. The individual grains 105 may be among themselves and with the electrode layer 104a electro conductive connected. Thus, the entirety of the sintered, electro conductive connected grains form the first electrode 104.

An individual grain 105 of the sintered body may itself comprise a sintered, conductive, porous granulate, wherein the granulate size may be comparable to the granulate size of the sintered body 104 depicted in FIG. 3a. The size of the grains of this granulate may be exemplarily between about 10 nm and about 1 μm.

As a consequence of the larger size of the individual grains 105 in FIG. 3b, the first electrode 104, the sintered body respectively comprises more space between the individual grains 105 compared to the sintered, conductive, porous granulate 104 in FIG. 3a. This enlarged space is at least partially filled with a conductive material, e.g., an electrolyte, a metal or a semiconducting material, forming the second electrode 108 of the semiconductor device 100. The first electrode 104 and the electrode layer 104a may be electrically insulated against the second electrode 108 by a dielectric layer 110, as already described in context to FIG. 3a.

In the embodiment of FIG. 3b, the semiconductor device is also a capacitor formed by the first electrode 104, the second electrode 108 and a dielectric 106 separating and electrically insulating the first and the second electrode and being integrated into a semiconductor layer 102.

By using the sintered, conductive, porous granulate, a large area for a capacitor can be made available by the pores of the porous sinter body. By the semiconductor device described in the embodiments with respect to FIGS. 3a, 3b an increase in specific area capacitance for integrated capacitors may thus be achieved. Conventional integrated capacitors only make a limited specific capacitance available. Regarding the formula for the capacitance C of a simple plate capacitor:

$$C = {ɛ}_{0} {ɛ}_{r} \frac{A}{d} ,$$

wherein ^{∈}0 corresponds to the dielectric permittivity, ^{∈}r corresponds to the relative permittivity, A to the area, and d to the distance of the electrodes, it can be seen that the capacitance C of a capacitor will be the greater, the greater the electrode area A and the material-specific dielectric number ^{∈}r, and the more densely the electrodes are located with respect to each other (d). The simplest way of increasing the specific capacitance is the enlargement of the surface. Usually, this is done by the employment of surface-enlarging techniques, such as the deep trench technology. The invention allows for the realization of a substantially higher surface per defined silicon volume, and hence a substantially greater capacitance per defined silicon surface, which is given by the chip design. That is, by the use of the sintered, conductive, porous granulate in the semiconductor device as an electrode, the surface of the capacitor can be increased substantially. The sintered, conductive, porous granulate or sinter body may, for example, consist of tantalum, niobium or aluminum, which may be converted into a nanogranulate matrix by sintering.

In the discrete device technology, the use of, for example, sintered tantalum powder is one possible technique for producing the smallest poled capacitors with large capacitance.

Through the integration of the powder sinter technique into the silicon processing technology according to an embodiment of the present invention, the surface enlargement by the use of sinter bodies, which have a large surface through their porous constructions, also may be utilized in the silicon technology.

The semiconductor layer 102 may, for example, be silicon or another semiconducting material, such as gallium arsenide (GaAs), indium phosphide (InP), silicon carbide (SiC), gallium nitride (GaN), or other semiconducting materials. The semiconductor layer 102 may comprise a depression, which is lined with one or more barrier layers 110, 112 (with two barrier layers in FIGS. 3a,b). The barrier layer may, for example, be silicon nitride, titanium nitride or other diffusion stop layers. Thus, it may be a multi-layer system, which serves as a diffusion barrier for a metal electrode layer 104a and the sintered, conductive, porous nanogranulate matrix 104 with respect to the semiconductor layer 102. The electrode layer 104a may be formed as an input lead or conductive path to the first electrode, which is formed by the sinter body 104, wherein the electrode layer 104a is in electrical contact with parts of the sinter body 104, i.e., the sintered, conductive, porous granulate. In embodiments of FIGS. 3a, 3b, the surface of the sintered, conductive, porous granulate 104 and the parts of the electrode layer 104a, which are not in contact with the parts of the sintered, conductive, porous granulate are covered with a dielectric material 106. This surface coverage may, for example, be achieved by electrochemical oxidation. For example, if materials such as tantalum, niobium or aluminum are used for the nanogranulate matrix, an amorphous oxide layer may be formed on the corresponding surfaces, which comprise a low leakage current behavior for a capacitor due to their structures, through anodic oxidation of these materials. Through the employment of the electrochemical oxidation, which is a voltage-dependent self-limiting process, a defect-free dielectric deposition across the large surface of the sinter body, i.e., the sintered, conductive, porous granulate, is possible.

The embodiments described in FIGS. 3a, 3b may, for example, be semiconductor devices with a polar integrated capacitor. The anode may thus be formed by the sintered, conductive, porous granulate. Depending on the material for the sinter body, a corresponding oxide layer may thus be produced. For example, by using tantalum, a dielectric tantalum pentoxide (Ta₂O₅) layer, by using niobium, a niobium pentoxide (Nb2O5) layer, or, for example, by using aluminum, an aluminum oxide (Al₂O₃) layer may be produced. This oxide layer may form the dielectric of the capacitor. The voltage strength of the resulting oxides (Al₂O₃, Ta₂O₅, Nb₂O₅) may be very high at about 4-10 MV/cm. Since the voltage strength can be adjusted in targeted manner by the anodic oxidation or formation, the thickness of the oxide layer varies with the nominal voltage of the capacitor.

It is, however, also possible that other dielectric materials, for example, organic materials, are employed as dielectric material or dielectric for the integrated capacitor.

The second electrode 108, which at least partially covers the dielectric material 106, wherein the dielectric material electrically insulates the second electrode from the first one, may, for example, be an electrolytic electrode. It is, however, also possible that it is a metallic or semiconducting electrode. In the embodiments in FIGS. 3a, 3b, it may be a polar integrated capacitor, wherein the sinter body represents the anode, and the second electrode the cathode. The second electrode may be an electrode of a manganese dioxide electrolyte, a polymer electrolyte, TiN or TaN, for example. Manganese dioxide (MnO₂) has semiconducting properties with n-type conductivity. Since manganese dioxide has a reduced conductivity and TiN or TaN a high conductivity, the series resistance is smaller using TiN or TaN.

The material used for the second electrode depends on the type of the integrated capacitor to be realized. An electrolytic second electrode, as just described, may be used for the production of polar integrated capacitors. That is, the first electrode or anode electrode is the plus pole, and the second electrode, which may, for example, be produced by a solid electrolyte, forms the cathode of the capacitor. A wrong polarity, a too high voltage present, or a ripple current overload may lead to a short or destruction of the semiconductor device with integrated capacitor.

In a further embodiment of the present invention, for example, a metallic second electrode may be used for realizing a non-polar capacitor. When using a metallic second electrode, the device may have formed a further dielectric intermediate layer, which may consist of, e.g., aluminum oxide, between the dielectric material, which covers the surface of the sinter body, and the second electrode. The further dielectric intermediate layer, for example, of aluminum oxide (Al₂O₃), may prevent an interaction between the first dielectric material such as Ta₂O₅ or Nb₂O₅ and the second electrode. The further dielectric intermediate layer may comprise a thickness of about 5 nm. Thereby, shorts and a chemical interaction between the second electrode, which may comprise metal and the sintered, conductive, porous granulate can be avoided.

In a further embodiment of the present invention, a semiconductor device may comprise a semiconductor layer with a first electrode, which is formed by a sintered, conductive, porous granulate. The sintered, conductive, porous granulate may, however, also be formed on the semiconductor layer or in or on at least one insulating layer arranged on the semiconductor layer. In other words: It is also possible to form the semiconductor device so that the sintered, conductive, porous granulate is arranged on the semiconductor layer or in a dielectric layer, a so-called inter-layer dielectric (ILD) layer. The semiconductor device may comprise, as described in connection with FIGS. 3a, 3b, corresponding barrier layers and/or an electrode layer, in order to form an integrated capacitor structure. The use of the powder sinter technique in the standard silicon technology may also be employed for forming integrated capacitors on a semiconductor substrate or in one or more dielectric layers arranged on the semiconductor layer, for example.

In embodiments of the invention, the nanogranulate matrix 104 may be formed by grains 105, which have a grain size of, for example, about 10 nm to about 1 μm. By sintering, the grains 105 may be grown together to a porous conglomerate 104 electrically connected. The sintered conglomerate 104, or the sinter body, comprises a large surface with a coral-like or sponge-like surface structure. The sintered material may, for example, be niobium, tantalum or also aluminum, as mentioned above, but the employment of other materials is also possible. In embodiments of the invention, the second electrode 108 may be formed so that it at least partially penetrates and fills the pores or hollows of the nanogranulate matrix. In embodiments of the invention, the semiconductor device may, for example, have a length and width of about 100 μm×100 μm and a depth of about 25 μm.

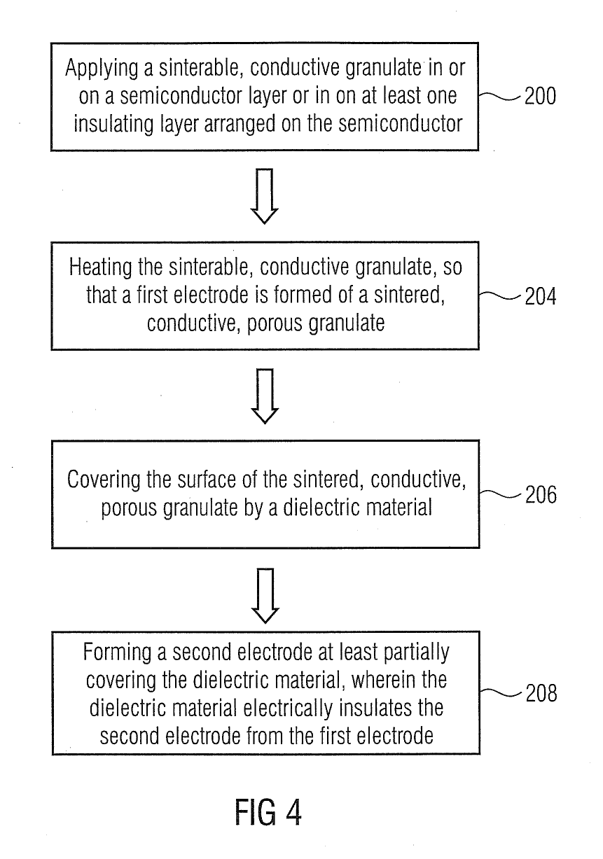

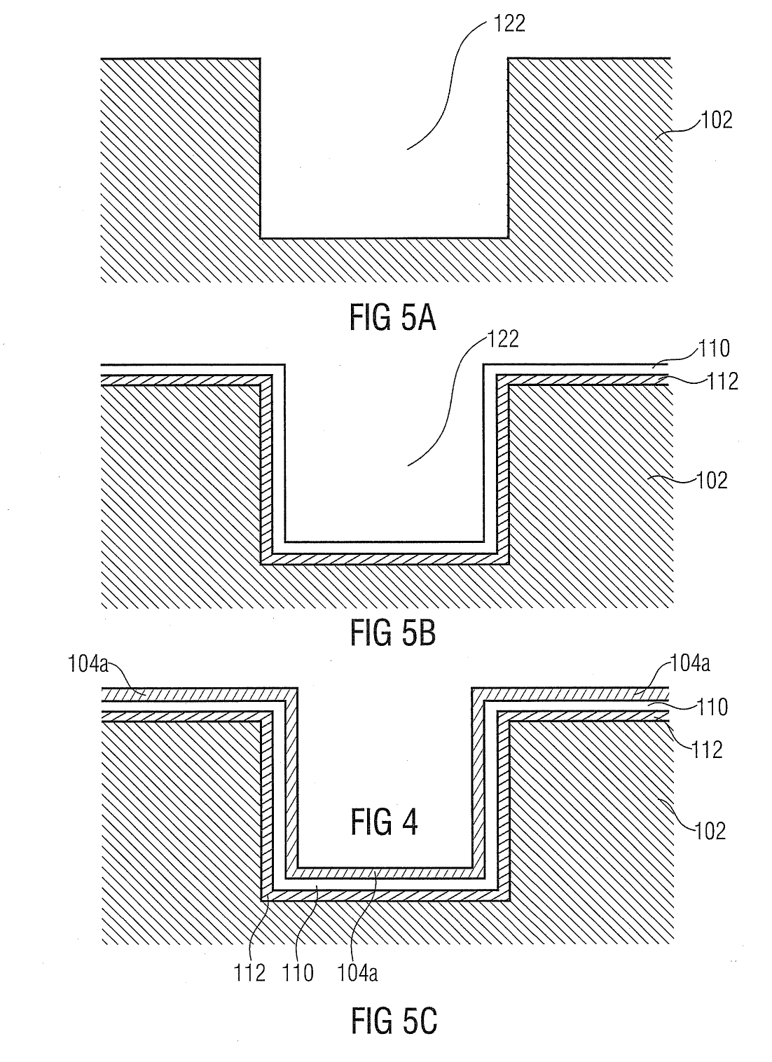

In FIG. 4, an embodiment of the method for producing a semiconductor device is illustrated in a flowchart. In this embodiment, in step 200 the method for producing a semiconductor device comprises applying a sinterable, conductive granulate in or on a semiconductor layer or in or on at least one insulating layer arranged on the semiconductor layer, and in step 204 heating the sinterable, conductive granulate, so that the first electrode is formed of a sintered, conductive, porous granulate. Moreover, the method in step 206 comprises covering the surface of the sintered, conductive, porous granulate by a dielectric material, and in step 208 forming a second electrode, which at least partially covers the dielectric material, wherein the dielectric material electrically insulates the second electrode from the first electrode.

Applying the granulate to be sintered, the sinterable conductive granulate, may, for example, be done by means of a screen-printing method. Here, the granulate to be sintered may be applied into a depression of a semiconductor layer or on a semiconductor layer, or also in or on at least one insulating layer arranged on the semiconductor layer. This may be a so-called inter-layer dielectric (ILD) layer. The nanogranulate, which may be applied by means of a screen-printing method, may, for example, be a tantalum or niobium paste. The nanogranulate, the sinterable conductive granulate, may have a correspondingly high overall surface.

In a further embodiment of the method for producing the semiconductor device, forming a recess or depression in the semiconductor layer or in a dielectric layer arranged above the semiconductor layer may precede applying a sinterable, conductive granulate. Forming a recess or depression in the semiconductor layer or an overlaying insulation layer may, for example, be done by wet-chemical etching, dry etching, by laser ablation or other conventional methods for producing depressions or recesses in semiconductor structures.

Furthermore, forming a recess may comprise depositing one or more barrier or diffusion layers by means of conventional semiconductor processing technology in the recess. The barrier or diffusion layers may, for example, be silicon nitride or titanium nitride layers. It may be the task of the one or more barrier layers or of the multi-layer system to prevent or suppress diffusion of metal from the first electrode into the semiconductor layer, which may, for example, consist of silicon.

In step 204, heating the sinterable, conductive granulate may be, for example, done by inert gas or vacuum sintering at about 1100° C., so that an electrically interconnected nanogranulate matrix with a large surface develops. This nanogranulate matrix or the sintered, conductive, porous granulate may, for example, be covered with a dielectric layer or a dielectric material by anodic oxidation. Alternatively, the dielectric material may be applied by other thin film techniques or other techniques. For example, if the nanogranulate matrix is tantalum or niobium or aluminum, a defect-free dielectric formation across the large surface of the nanogranulate matrix, the sinter body, may take place by anodic oxidation, which is a voltage-dependent self-limiting process, as already explained above.

Forming, in step 208 the second electrode may, for example, be done by applying a metal layer or an electrolytic electrode. For example, the electrically insulating, porous sinter body may be soaked in an aqueous manganese (II) nitrate solution, which is then decomposed to manganese dioxide in a thermal process. Thereby, a solid electrolyte, which represents the second electrode of the integrated capacitor, develops.

In another embodiment of the present invention, the second electrode is made by a so-called atomic layer deposition. The atomic layer deposition (ALD) is a strongly altered chemical vapor deposition (CVD) method for depositing thin layers. The layer growth in the atomic layer deposition takes places in a cyclical manner, wherein the cycle is repeated until a desired thickness of the second electrode is reached. The layer growth may be self-controlling in the ALD, i.e., the amount of the layer material deposited in each cycle is constant. The atomic layer deposition may also be used so that the dielectric material, which electrically insulates the sinter body from the second electrode, is at least partially covered. That is, with the aid of the atomic layer deposition, the metallic second electrode may at least partially penetrate into pores or cavities of the nanogranulate matrix and thus form as large a capacitor area as possible.

It is also possible that the second electrode is produced by other techniques as evaporation or sputtering with a semiconducting or conducting metallic material. But also low-molecular organic conductive molecules may be evaporated, or electrically conductive polymers or other soluble, semiconducting organic materials for forming the second electrode may be applied by means of spin coating techniques or doctor blade techniques.

In a further embodiment of the method for producing a semiconductor device, after forming at least one barrier layer for accommodating the diffusion, applying an electrode layer, which serves as lead electrode layer for the first electrode, takes place. To this end, heating or sintering the sinterable, conductive granulate is performed so that the first electrode is electrically connected to the electrode layer. Applying a sinterable, conductive granulate may be performed so that niobium, tantalum or aluminum is used. Furthermore, heating or sintering the sinterable, conductive granulate may be performed so that the first electrode of the sintered, conductive, porous granulate may be formed by grains of a grain size of approximately about 10 nm to about 1 μm, which grow together to a porous conglomerate connected in electrically conductive manner by heating.

In another embodiment, sintering is performed by a so-called solid-phase sintering, liquid-phase sintering or reaction sintering. During sintering, melting and diffusion processes between the sinterable, conductive granulate may occur, so that bridges, necks or connections between the grains of the granulate form. Thereby, an electrically interconnected conglomerate, the sinter body, may develop.

In a further embodiment of the method for producing a semiconductor device, applying or introducing a sinterable, conductive granulate is done by means of printing techniques, such as the screen-printing technique. In a further embodiment, the dielectric material may be generated by means of anodic oxidation of the sintered, conductive, porous granulate. If the sintered granulate comprises niobium, tantalum or aluminum, an oxide layer of aluminum oxide, niobium pentoxide or tantalum pentoxide can be generated by the anodic oxidation of the corresponding materials.

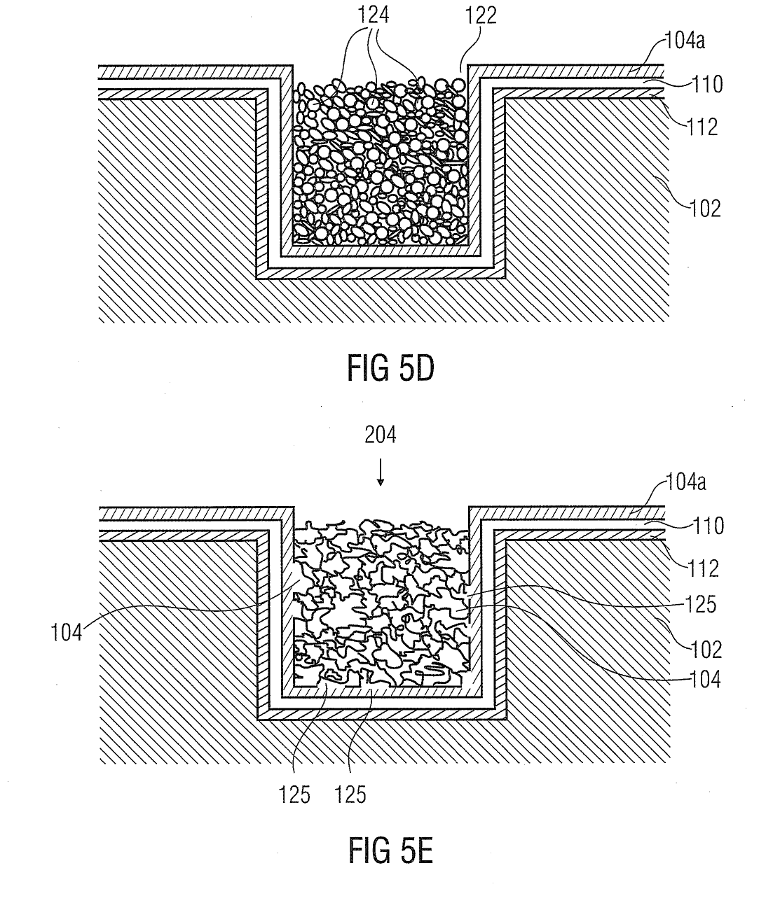

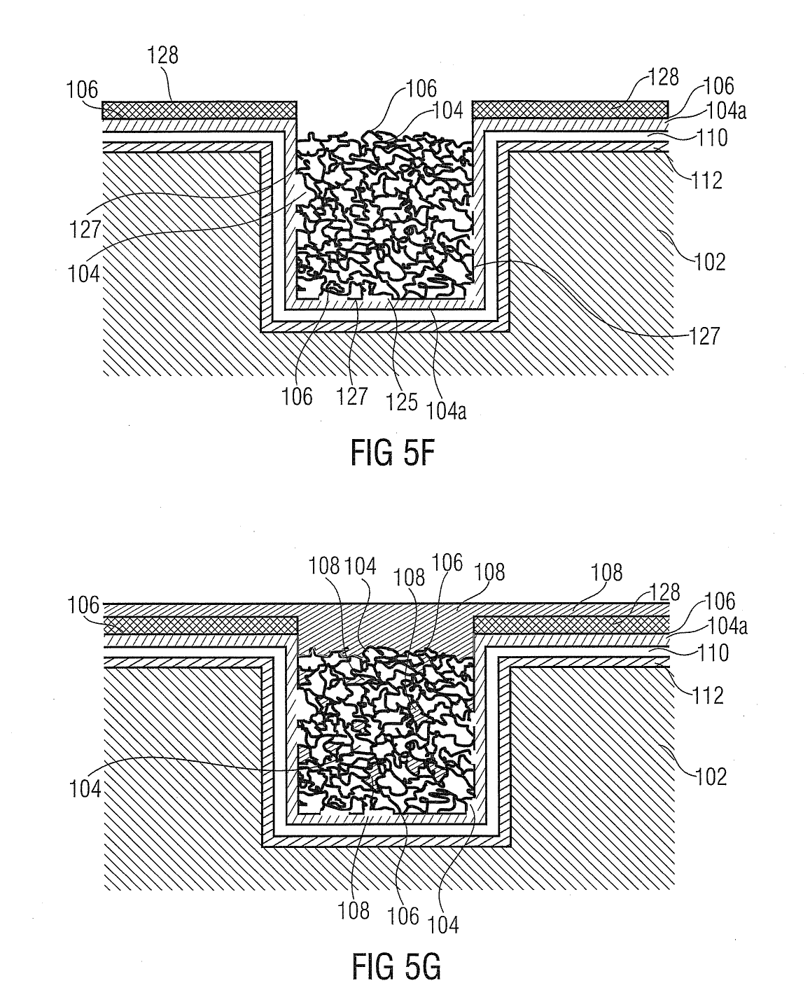

In FIGS. 5a-5g, a further embodiment of the method for producing a semiconductor means is illustrated. In FIG. 5a, a silicon substrate layer 102 is illustrated with a depression 122, which has been created by means of a standard semiconductor process technique, such as a trench etch, for example. The trench structure may, for example, have a length of about 100 μm, a width of about 100 m, and a depth of about 25 μm. It is also possible that the depression or recess is created in an inter-layer dielectric layer arranged on the semiconductor layer 102.

As illustrated in FIG. 5b, the semiconductor device may, for example, comprise two barrier layers 110, 112, which are formed so that they line the depression 122. The barrier layers may be, for example, silicon nitride, titanium nitride, tantalum nitride, hafnium nitride etc., supposed to prevent a diffusion process of the first electrode, which is applied in the following, into the silicon substrate. The one or more barrier layers thus separate the semiconductor layer from a first electrode to be formed. Forming or depositing the corresponding barrier layers may be done with the aid of conventional methods employed in the semiconductor technology.

As illustrated in FIG. 5c, an input-lead or an electrode layer 104a for the first electrode formed subsequently may be deposited. The input-lead may, for example, be a 15 nm-thick tantalum nitride layer and a 60 nm-thick tantalum layer. The electrode layer 104a may, however, also comprise other metals or conductive materials deposited with usual production methods of the semiconductor technology.

As shown in FIG. 5d, inserting a sinterable, conductive granulate 124 into the depression 122 is done thereafter. The sinterable, conductive granulate 124 does not show any intergrowth or interconnection between the individual granulate grains in this phase. Introducing the nanogranulate, e.g., of tantalum or niobium paste, may be done by means of printing techniques, such as the screen-printing technique. But it is also possible that the sinterable, conductive granulate is introduced in the form of powder or of powder masses. By a subsequent sintering 204, as illustrated in FIG. 5e, a first electrode is formed of a sintered, conductive, porous granulate 104 in electrical contact 125 with the electrode layer 104a from the sinterable, conductive granulate 124. Sintering 204 may, for example, be performed as an inert sintering at a temperature of about 1100° C., so that material bridges between the individual granulate grains form by melting and diffusion processes, so that a conductively connected conglomerate 104 of the granulate grains develops. This conglomerate or the nanogranulate matrix 104 distinguishes itself by a porous structure, which is why it has a large surface.

Sintering may also be regarded as compacting crystalline, grained or powdery substances by growing the crystallites together at corresponding heating. In sintering, however, not all components are allowed to be melted. Growing together the crystallites or grains of the granulate may take place by diffusion, i.e., a solid-solid reaction, but also one of the components in question may melt and wet the more refractory component, coat the same, and connect the same when hardening. This is referred to as melt-sintering. The sinter body distinguishes itself by the sinter necks formed between the individual granulate grains.

As illustrated in FIG. 5f, the sintered, conductive, porous granulate is oxidized subsequently, so that the surface of the sintered, conductive, porous granulate is covered with an oxide layer 106. For example, this may take place by anodic oxidation of the corresponding sinter body. In the anodic oxidation, suitable solutions, such as sulfur-, chromic-, phosphoric- or oxal-acid are treated electrolytically, i.e., decomposed by electric current. An oxide layer forms on the corresponding anode surface.

As already mentioned above, for example, niobium pentoxide when using niobium, aluminum oxide when using aluminum, and tantalum pentoxide when using tantalum may be deposited on the surface of the sinter body. Through this anodic oxidation, for example, also areas 127 of the electrode layer 104a that have not established a fixed connection to the sinter body 104 during sintering may be covered with an oxide layer 106 for electrical insulation against a second electrode, deposited later on. But it is also possible that an insulation layer, which surrounds the surface of the porous sinter body 104 with an insulating layer 106, is produced with the aid of other fabrication techniques.

As schematically illustrated in FIG. 5f, it is also possible that further dielectric layers 128 are applied onto the electrode layer 104a by mask processes, in order to electrically insulate the electrode layer 104a from the second electrode 108 to be deposited subsequently.

In FIG. 5g, the semiconductor device is illustrated after depositing a second metallic electrode 108 with atomic layer deposition (ALD), so that the oxide layer 106 electrically insulates the second electrode 108 from the first electrode 104. The atomic layer deposition is an altered chemical vapor deposition (CVD) method, in which the reactants, e.g., the precursors TiCl₄ and NH₃ are supplied into a vacuum chamber. In the atomic layer deposition, the layer growth takes place in cyclical manner, wherein the chamber is flooded cyclical with nitrogen. The atomic layer deposition is suited well for depositing the layer stacks within the nanogranulate matrix 104. That is, it is possible to at least partially form the second electrode 108 within the porous sinter body 104 with the aid of the atomic layer deposition. Thereby, the surface enlargement can be achieved, which is important for an increase in the specific area capacitance of the integrated capacitor.

In a further embodiment of the invention, prior to depositing a second electrode, forming a dielectric intermediate layer, which covers the oxide layer 106, so that the oxide layer and the dielectric intermediate layer (not shown in FIG. 5g) electrically insulate the second electrode 108 from the first electrode 104, takes place. This intermediate layer may be, for example, aluminum oxide (Al₂O₃) preventing a chemical interaction between the dielectric layer 106 and the second electrode. Owing to its excellent conformity and chemical stability, Al₂O₃ is well suited. It inhibits the exchange of oxygen between the second electrode 108 and, for example, a tantalum oxide dielectric layer 106 (if the porous sinter body 104 consists of tantalum).

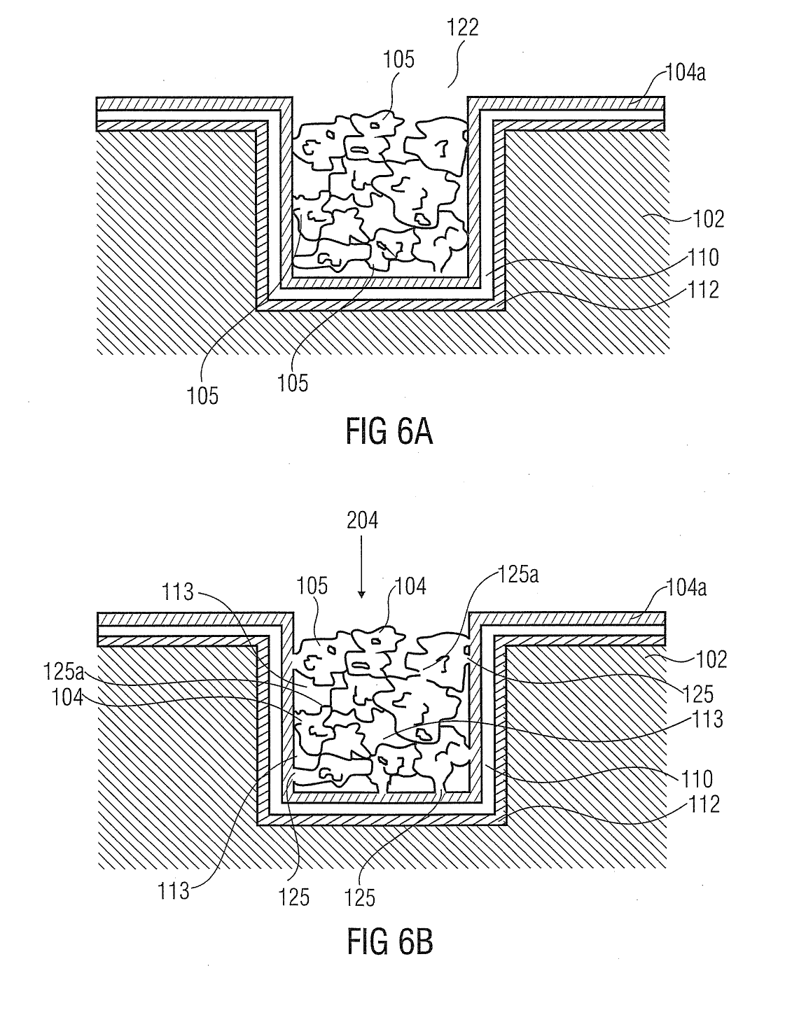

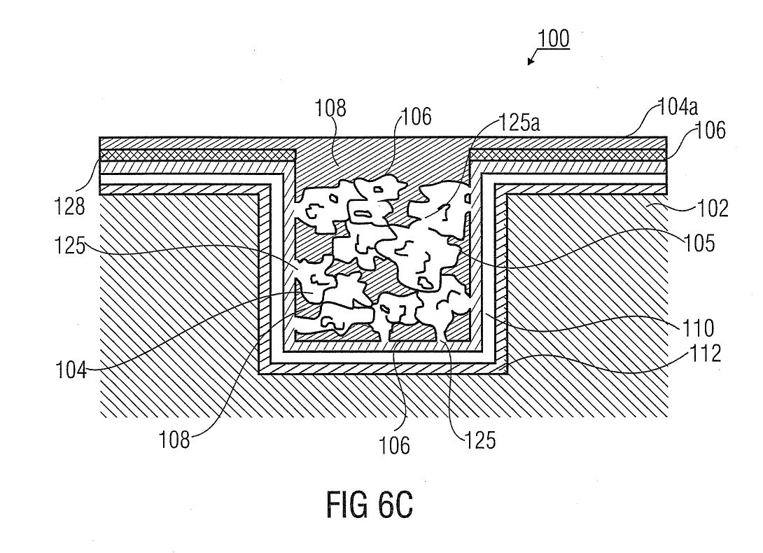

FIGS. 6a-6c show another embodiment of the method for producing a semiconductor device. As depicted in FIG. 6a a pre-sintered, conductive, porous granulate 105 may be inserted in a depression 122 of a semiconductor layer 102. The semiconductor layer may comprise barrier layers 110 and 112 and an electrode layer 104a, wherein the depression and the layers 110,112,104a may be fabricated in a way described above, e.g., in connection to the FIGS. 5a-5c. The size of the pre-sintered granulate grains 105 may be approximately between about 1 μm and about 10 μm. The grain size may be, for example, about 3 μm. The pre-sintered conductive, porous granulate grains 105 may themselves comprise smaller conductive, porous granulate grains forming them. The grains 105 may comprise, for example, tantalum, niobium or aluminum. The pre-sintered, conductive, porous granulate may inserted by means of printing techniques, e.g., screen-printing techniques. The pre-sintered, conductive, porous granulate, the pre-sintered sinter body respectively, may have a defined surface size of about 0.3 m2/g to about 2 m2/g.

By a subsequent sintering 204, as illustrated in FIG. 6b of the pre-sintered conductive, porous granulate a first electrode is formed of a sintered, conductive, porous granulate 104 in electrical contact 125 with the electrode layer 104a from the pre-sintered, conductive, porous granulate. Sintering may, for example, be performed as an inert gas or vacuum sintering at a temperature between about T=900° C. to 1200° C., so that material bridges 125a between the individual granulate grains form by melting and diffusion processes. Therein the individual granulate grains 105 are electro conductive connected among themselves and with the electrode layer 104a. This sintered, conductive, porous conglomerate forms therewith the first electrode 104. The first electrode 104 comprises a large surface. Because of the larger size of the pre-sintered, conductive, porous granulate grains 105 compared to the granulate grains inserted in the embodiment described in FIG. 5d the empty space 113 between the individual grains 105 is enlarged.

As depicted in FIG. 6c the sintered, conductive, porous granulate and the parts of the electrode layer 104a, which are not connected to the granulate are oxidized subsequently as described in connection with FIG. 5f. A oxide layer 106 forms the dielectric for a capacitor between the first electrode 104 and the second electrode 108. The second electrode 108 may be applied as described in connection with FIG. 5g. The semiconductor device 100 may comprise further layers, for example, dielectric layers, as indicated in FIG. 6c by the layer 128. Those layers may be produced by conventional means of semiconductor process technology.

The second electrode 108 may be formed by an atomic layer deposition or other methods or means as described therein. Since the empty space 113 (FIG. 6b) between granulate grains 105, forming the first electrode 104, is enlarged, the material for the second electrode 108 may be easier applied on the sintered, conductive, porous granulate so that the second electrode 108 comprise a larger area in contact with the dielectric 106 covering the first electrode 104 than a sintered, conductive, porous granulate with smaller grains 105. Hence the area capacitance of the formed capacitor may be enlarged.

Through the embodiments illustrated in FIGS. 5a-5g, 6a-6c a capacitor integrated in a silicon substrate may thus be produced. In these embodiments, the integrated capacitor comprises a sinter body, which is formed as a first electrode of the integrated capacitor and may be controlled via an electrode layer, to which it is electrically connected. This electrode layer and the first and second electrodes are lined by diffusion barriers, which are formed in the depression, in which the electrodes, the sinter body and the electrode layer are formed, and thereby separated with respect to the semiconductor substrate. In this embodiment, the surface of the first electrode comprises an oxide layer as a dielectric for the integrated capacitor. This capacitor dielectric may, as explained in the embodiment, for example, be achieved by anodic oxidation of the sinter body. Here, the sinter body may be a tantalum, niobium or aluminum sinter body. This oxide layer may be covered by a further dielectric intermediate layer in order to prevent a chemical interaction between the oxide layer and a second electrode. The second electrode of the integrated capacitor may be produced by atomic layer deposition, so that metallic layer stacks may form within and above the sinter body or the nanogranulate matrix. The second metallic electrode of the integrated capacitor may, for example, be electrically insulated with respect to the electrode layer or other parts of the first electrode via further insulation structures, indicated by the layer 128.

In a further embodiment of a method for producing a semiconductor device, the integrated capacitor may, for example, be produced by means of a screen-printing technique on the surface of the semiconductor substrate or at least on an insulation layer, which was arranged on the semiconductor substrate, in the form of a “nanogranulate matrix heap”. This may, for example, again be achieved with the aid of the screen-printing technique. The remaining production may be performed as set forth in the preceding embodiments, and be adapted correspondingly by someone familiar with the semiconductor process technology.

In embodiments of the present invention, it is shown that the semiconductor device may be formed as integrated polar capacitor or bipolar capacitor, and in other embodiments it is shown that, by the method for producing a semiconductor device, a polar or bipolar capacitor integrated in the semiconductor process technology with a sinter body and a correspondingly large surface, and hence capacitance, can be produced.

Through the method for producing a semiconductor device, large, previously not realized surfaces, and hence correspondingly high, integrated poled or unpoled capacitances can be realized in a microelectronics chip, that is on-chip.

While the invention has been shown and described with reference to the specific embodiments, it should be understood by those skilled in the art, that various changes in form and detail may be made without departing from the spirit and scope of the invention as defined by the appended claims. The scope of the invention is thus indicated by the appended claims and all changes that come within the meaning and range of equivalency of the claims are intended to embrace.

What is claimed is:

1. A semiconductor device, comprising:
a semiconductor layer;
a first electrode formed by a sintered, conductive, porous granulate and formed in or on the semiconductor layer or in or on at least one insulating layer arranged over the semiconductor layer;
a dielectric material covering a surface of the sintered, conductive, porous granulate; and
a second electrode at least partially covering the dielectric material, wherein the dielectric material electrically insulates the second electrode from the first electrode.

2. The semiconductor device according to claim 1, wherein the first electrode is formed in a recess in the semiconductor layer or in a recess in the at least one insulating layer arranged on the semiconductor layer.

3. The semiconductor device according to claim 1, wherein the first electrode is separated from the semiconductor layer by at least one barrier layer.

4. The semiconductor device according to claim 1, wherein the first electrode is electrically connected to an electrode layer.

5. The semiconductor device according to claim 1, wherein the sintered, conductive, porous granulate is formed by grains of a grain size from 10 nm to 1 μm that have grown together by sintering into a porous conglomerate connected in an electrically conductive manner.

6. The semiconductor device according to claim 1, wherein the sintered, conductive, porous granulate is formed by grains of a grain size from approximately 1 μm to 10 μm that have grown together by sintering into a porous conglomerate connected in electrically conductive manner; and wherein the grains of the grain size from approximately 1 μm to 10 μm themselves comprise sintered, conductive, porous granulate grains of a grain size from approximately 10 nm to 1 μm.

7. The semiconductor device according to claim 1, wherein the sintered, conductive, porous granulate comprises niobium (Nb), tantalum (Ta) or aluminum (Al).

8. The semiconductor device according to claim 1, wherein the dielectric material comprises a first dielectric material that covers the sintered, conductive, porous granulate, and a second dielectric material that covers the first dielectric material.

9. The semiconductor device according to claim 1, wherein the dielectric material comprises tantalum pentoxide (Ta₂O₅), niobium pentoxide (Nb₂O₅) or aluminum oxide (Al₂O₃).

10. The semiconductor device according to claim 8, wherein the second dielectric material comprises aluminum oxide (Al₂O₃).

11. The semiconductor device according to claim 1, wherein the second electrode is a metal, an electrolyte or an organic material.

12. A method for producing a semiconductor device, the method comprising:
applying a sinterable, conductive granulate in or on a semiconductor layer or in or on at least one insulating layer arranged on the semiconductor layer;
heating the sinterable, conductive granulate, so that a first electrode is formed of a sintered, conductive, porous granulate;
covering a surface of the sintered, conductive, porous granulate with a dielectric material; and
forming a second electrode at least partially covering the dielectric material, wherein the dielectric material electrically insulates the second electrode from the first electrode.

13. The method according to claim 12, further comprising forming a recess in the semiconductor layer or in the at least one insulating layer arranged on the semiconductor layer, wherein the sinterable, conductive granulate is applied in the recess.

14. The method according to claim 12, further comprising, prior to applying the sinterable, conductive granulate, forming at least one barrier layer, so that the semiconductor layer is separated from the first electrode.

15. The method according to claim 14, further comprising, after forming the at least one barrier layer and before applying the sinterable, conductive granulate, applying an electrode layer, and wherein heating the sinterable, conductive granulate is performed so that the first electrode is conductively connected to the electrode layer.

16. The method according to claim 12, wherein applying the sinterable, conductive granulate is performed so that the sinterable, conductive granulate comprises niobium (Nb), tantalum (Ta) or aluminum (Al).

17. The method according to claim 12, wherein heating the sinterable, conductive granulate is performed so that the first electrode of the sintered, conductive, porous granulate is formed by grains of a grain size of 10 nm to 1 μm, which grow together by heating into a porous conglomerate connected in an electrically conductive manner.

18. The method according to claim 12, wherein applying the sinterable, conductive granulate is performed by applying a pre-sintered, conductive, porous granulate in or on a semiconductor layer or in or on the at least one insulating layer arranged on the semiconductor layer; wherein the grain size of the pre-sintered, conductive, porous granulate is approximately between 1 μm to 10 μm.

19. The method according to claim 12, wherein applying the sinterable, conductive granulate comprises performing a screen-printing technique.

20. The method according to claim 12, wherein the dielectric material is generated by anodic oxidation of the sintered, conductive, porous granulate.

21. The method according to claim 12, wherein forming the second electrode comprises performing an atomic layer deposition (ALD) process.

22. A method for producing a semiconductor device, the method comprising:
forming a depression in a semiconductor layer or in at least one insulating layer arranged on the semiconductor layer;
forming at least one barrier layer in the depression;
forming an electrode layer over the at least one barrier layer;
introducing a sinterable, conductive granulate into the depression;
sintering the sinterable, conductive granulate, so that a first electrode of a sintered, conductive, porous granulate is formed in electrical contact with the electrode layer;
oxidizing the sintered, conductive, porous granulate, wherein the surface of the sintered, conductive, porous granulate is covered with an oxide layer; and
depositing a second electrode by atomic layer deposition (ALD) over the oxide layer, the oxide layer electrically insulating the second electrode from the first electrode.

23. The method according to claim 22, further comprising, prior to depositing the second electrode, forming a dielectric intermediate layer that covers the oxide layer, wherein the oxide layer and the dielectric intermediate layer electrically insulate the second electrode from the first electrode.

24. The method according to claim 22, wherein introducing a sinterable, conductive granulate is performed so that the sinterable, conductive granulate comprises niobium (Nb), tantalum (Ta), or aluminum (Al).

25. An integrated circuit, comprising:
a semiconductor layer;
a first electrode formed by a sintered, conductive, porous granulate and formed in or on the semiconductor layer or in or on at least one insulating layer arranged on the semiconductor layer;
a dielectric material covering the surface of the sintered, conductive, porous granulate; and
a second electrode at least partially covering the dielectric material, wherein the dielectric material electrically insulates the second electrode from the first electrode.
